(19) United States
(12) Patent Application Publication
(10) Pub. No.: US 2012/0094051 A1
(43) Pub. Date: Apr. 19, 2012

(54) ELASTOMERIC GRIP TAPE

(75) Inventor: Jonathan Chang, San Jose, CA (US)

(73) Assignee: DUCKLE GRIP & CO, San Jose, CA (US)

(21) Appl. No.: 13/237,639

(22) Filed: Sep. 20, 2011

Related U.S. Application Data
(63) Continuation-in-part of application No. 12/890,458, filed on Sep. 24, 2010.
(60) Provisional application No. 61/385,787, filed on Sep. 23, 2010.

(51) Int. Cl. B32B 7/02; B32B 3/26; B32B 3/24; B32B 37/12

(52) U.S. Cl. 428/41.8; 156/289; 156/275.7; 428/141; 428/137

(57) ABSTRACT

Elastomeric grip tape embodiments are presented including: an elastomeric layer, where the elastomeric layer is a low-abrasion layer having a hardness in a range of approximately 30 to 120 Shore A, and where the elastomeric layer includes a top surface formed having a first texture with a peak-valley depth in a range of approximately 0.000 to 0.500 inches; a pressure sensitive adhesive (PSA) layer formed along a bottom surface of the elastomeric layer. In some embodiments, elastomeric grip tapes further include an underlayer bonded with the bottom surface of the elastomeric layer where the PSA layer is formed along a bottom surface of the underlayer.

### PRIORITY CLAIM TO PROVISIONAL APPLICATION

A claim for priority is hereby made under the provisions of 35 U.S.C. §119 for the present application based upon U.S. Provisional Application No. 61/385,787, filed on Sep. 23, 2010, which is incorporated herein by reference.

### BACKGROUND

Embodiments of the present invention relate to low abrasion, non-skid surface tapes.

Many conventional grip tape solutions have focused generally on providing an abrasive surface that provides additional traction to an otherwise slippery surface such, for example, abrasive strips located on stair treads. Abrasive grip tape is generally well-known in the prior art. There have been several disclosed flexible sheets with non-skid surfaces and adhesive backing to be adhered to an underlying surface. Exemplary of such structures include: U.S. Pat. No. 6,921,566; U.S. Pat. No. 5,622,759; U.S. Pat. No. 3,578,550; and U.S. Pat. No. 3,227,604. However these structures rely on the engineering effect of abrasion in order to provide a non-skid surface, and none have been designed to provide adequate frictional characteristics while limiting the damaging effect of abrasiveness or offering a new low-abrasive method of providing a non-skid surface. Though these innovations are useful and may serve a specific purpose, they are not suitable for the purposes of some embodiments of the present invention.

For example, when skateboards and abrasive grip tape first emerged, the sport mainly consisted of flat land tricks that involved turning and carving. Modern skateboarding has evolved in the last 20 years with the addition of double kicktails and modern aerial tricks, which require a user to create frictional forces by sliding their foot across the board's surface or kicktails. Abrasive grip tapes utilized in skateboarding conventionally provide at least two important functions. The first function is to provide a non-skid surface so a user does not slip off while maneuvering the board. The second function relates to performance of tricks, wherein a user slides his/her shoe across the surface of the skateboard in order to create a frictional force, which manipulates the board into rotating, flipping or sticking to the user's feet in midair etc. To provide this frictional surface, abrasive grip tape of the prior art typically consists of laminated particles of silicon carbide, aluminum oxide or abrasive granules and the like to a flexible sheet material and utilizes the engineering effect of abrasion to create said frictional surface. In particular, silicon carbide and abrasive granules of the like are hard materials typically used for industrial grinding or cutting processes. However, when a user slides their shoe across the abrasive frictional surface of current grip tape of the prior art, extensive damage and accelerated wear and tear of the user's shoe may result. This sliding action may be likened to literally rubbing a shoe against sandpaper for several hours a day. Therefore the evolution of modern skateboarding and method for performing tricks has made abrasive grip tape of the prior art a big problem affecting shoe durability and accelerating its wear. Thus, although the prior art is feasible and useful for providing a frictional surface, it is not especially suitable for modern skateboarding.

Another problem inherent with conventional solutions composing of granules made from abrasive material laminated or adhered to a sheet such as abrasive grip tape, is that embedded granules are subjected to individual shear stresses and may be dislodged or worn down over time. Thus, granule loss or wear may cause the overall coefficient of friction (COF) to decrease over time with normal use. Yet another problem inherent with conventional solutions relates to granule characteristics such as sharpness, hardness and randomized pattern distribution. These characteristics can lead to surface contaminates such as chemicals, dirt, gum, etc. being trapped thus making cleaning very difficult or impossible. In some examples cleaning materials may be destroyed by abrasive granules. In other examples, abrasive granule patterns may make some form factors difficult to clean. As may be appreciated contaminated surfaces may also significantly reduce effectiveness of abrasion and ultimately overall COF.

It may be appreciated that many conventional abrasive grip tape applications suffer from similar problems as skateboarding where unwanted abrasion damage occurs. As such, elastomeric grip tapes are presented herein.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented below.

As such, elastomeric grip tape embodiments are presented including: an elastomeric layer, where the elastomeric layer is a low-abrasion layer having a hardness in a range of approximately 30 to 120 Shore A, and where the elastomeric layer includes a top surface formed having a first texture with a peak-valley depth in a range of approximately 0.000 to 0.500 inches; a pressure sensitive adhesive (PSA) layer formed along a bottom surface of the elastomeric layer. In some embodiments, elastomeric grip tapes further include an underlayer bonded with the bottom surface of the elastomeric layer where the PSA layer is formed along a bottom surface of the underlayer. In some embodiments, the elastomeric layer is manufactured from an elastomeric compound selected from the group consisting of: natural rubber, ethylene vinyl acetate (EVA), ethylene propylene diene monomer (EPDM), styrene-butadiene rubber (SBR), nitrile rubber (NBR), thermoplastic elastomers/thermoplastic vulcanizates (TPE/TPV), thermoplastic elastomer polyolefin (TPO), silicone rubber (SI,Q,VMQ), polyacrylic rubber, fluoroelastomers (FKM, FPM), flurosilicone rubber (FVMQ), tetrafluoro ethylene/propylene rubbers (FEPM), chlorosulfonated polyethylene (CSM), Ethylene propylene rubber (EPM), polyisoprene (IR), polybutadiene (BR), polyurethane rubber, and elastomer-based foams. In some embodiments, the underlayer is manufactured from a compound selected from the group consisting of: polypropylene (PP), polyvinyl chloride (PVC), polyethylene terephthalate (PET), nylon, polyethylene (PE), polycarbonate (PC), acrylonitrile butadiene styrene (ABS) and any combination of those compounds. In some embodiments, the underlayer further includes a lamination adhesive for bonding with the bottom surface of the elastomeric layer where the lamination adhesive is selected from the group consisting of a heat activated adhesive and a non-heat activated adhesive.

In other embodiments, methods of manufacture of elastomeric grip tape embodiments include: providing an elastomeric layer, where the elastomeric layer is a low-abrasion layer having a hardness in a range of approximately 30 to 120 Shore A, and where the elastomeric layer includes a top surface formed having a first texture with a peak-valley depth in a range of approximately 0.000 to 0.500 inches; providing a pressure sensitive adhesive (PSA) layer; and bonding the PSA layer with a bottom surface of the elastomeric layer. In some embodiments, methods further include providing an underlayer; bonding the elastomeric layer with the underlayer; providing the pressure sensitive adhesive (PSA) layer; and bonding the PSA layer with a bottom surface of the underlayer. In some embodiments, methods further include providing an underlayer, underlayer including a PSA layer bonded to a bottom surface of the underlayer; bonding the elastomeric layer with the underlayer. In some embodiments, methods further include applying a release/carrier layer with the PSA layer for temporarily protecting the PSA layer. In some embodiments, methods further include treating the underlayer by a treatment selected from the group consisting of: corona treatment, flame treatment and plasma treatment.

In other embodiments, elastomeric grip tapes are presented including: an elastomeric layer, where the elastomeric layer is a low-abrasion layer having a hardness in a range of approximately 30 to 120 Shore A, and where the elastomeric layer includes a top surface formed having a first texture with a peak-valley depth in a range of approximately 0.000 to 0.500 inches; an underlayer bonded with the bottom surface of the elastomeric layer, where the underlayer includes lamination adhesive for bonding with the bottom surface of the elastomeric layer; a pressure sensitive adhesive (PSA) layer formed along a bottom surface of the underlayer; and a release/carrier layer releasably applied with the PSA layer for temporarily protecting the PSA layer.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustrative representation of a cross-sectional view of a portion of an elastomeric grip tape in accordance with embodiments of the present invention;

FIG. 2 is an illustrative representation of a cross-sectional view of a portion of an elastomeric grip tape applied to a surface in accordance with embodiments of the present invention;

FIG. 3 is an illustrative representation of an elastomeric grip tape as applied to a skateboard in accordance with embodiments of the present invention;

FIG. 4 is an illustrative representation of a cross-sectional view of a portion of an elastomeric grip tape in accordance with embodiments of the present invention;

FIG. 5 is an illustrative flowchart of methods for manufacturing of an elastomeric grip tape in accordance with embodiments of the present invention; and

FIG. 6 is an illustrative graphical representation of coefficient of friction vs. surface roughness in accordance with embodiments of the present invention.

### DETAILED DESCRIPTION

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

As utilized herein, the term elastomeric is substantially synonymous with and includes a broad class of compounds of elastomers and elastomer mixes which elastomer mixes may include without limitation, plastic only blends, thermoplastics, and vulcanates without limitation and without departing from embodiments disclosed herein.

As noted above, one problem inherent with conventional solutions composing of granules of abrasive material laminated or adhered to a sheet such as abrasive grip tape, is that embedded granules are subjected to individual shear stresses and may be dislodged or worn down over time. Thus, granule loss or wear may cause the overall coefficient of friction (COF) to decrease over time with normal use. In accordance with embodiments provided herein, extra process steps of laminating or adhering granules to a sheet such as grip tape may be eliminated and therefore loss of COF may be consequently limited due to wear because shear stresses are distributed across the entire surface of the invention as well as being elastic. Thereby, embodiments disclosed herein may last longer and maintain a steady COF throughout its life as compared to wear problems associated with conventional solutions.

Yet another problem inherent with conventional solutions identified above relates to granule characteristics such as sharpness, hardness and randomized pattern distribution. These characteristics can lead to surface contaminates such as chemicals, dirt, gum, etc. being trapped thus making cleaning very difficult or impossible. In some examples cleaning materials may be destroyed by abrasive granules. In other examples, abrasive granule patterns may make some form factors difficult to clean. As may be appreciated contaminated surfaces may also significantly reduce effectiveness of abrasion and ultimately overall COF. Embodiments provided herein are water and chemical-resistant and non-abrasive, therefore it may be easy to clean the surface with commonly available materials, such as, a cloth and water. Thus, embodiments may be longer lasting and maintain a consistent COF as compared to contamination and cleaning problems associated with conventional solutions.

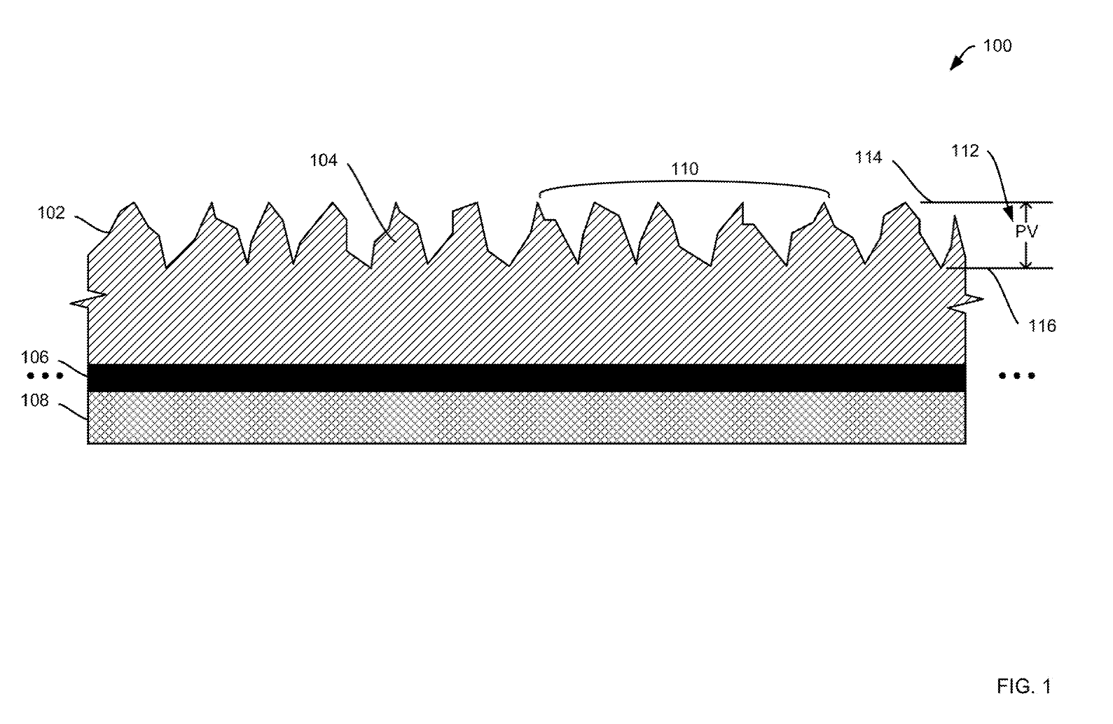

FIG. 1 is an illustrative representation of a cross-sectional view 100 of a portion of an elastomeric grip tape in accordance with embodiments of the present invention. In particular, the illustrated portion represents an embodiment prior to application to a surface. As illustrated elastomeric layer 104 may provide a low abrasion frictional surface to another surface. In embodiments, surfaces may be rigid or flexible without limitation. In addition, surfaces may be planar or non-planar without limitation. Conformance with non-planar surfaces is possible because of the elasticity of compounds utilized in embodiments provided herein. As such, elastomeric layers may be manufactured from any number of elastomeric compounds including without limitation: natural rubber, ethylene vinyl acetate (EVA), ethylene propylene diene monomer (EPDM), styrene-butadiene rubber (SBR), nitrile rubber (NBR), thermoplastic elastomers/thermoplastic vulcanizates (TPE/TPV), thermoplastic elastomer polyolefin (TPO), silicone rubber (SI,Q,VMQ), polyacrylic rubber, fluoroelastomers (FKM, FPM), Flurosilicone rubber (FVMQ), Tetrafluoro ethylene/propylene rubbers (FEPM), Chlorosulfonated Polyethylene (CSM), Ethylene propylene rubber (EPM), Polyisoprene (IR), Polybutadiene (BR), Polyurethane rubber, and elastomer-based foams. In embodiments, elastomeric layers may have a thickness in a range of approximately 0.010 to 0.500 inches, more preferably 0.030 inches. In addition, in embodiments, elastomeric grip tape may be produced without limitation in rolls and sheeted to various lengths of rolls, sheets, or shapes.

As noted above, in some conventional solutions, highly abrasive materials may be utilized to create a highly frictional surface. While highly abrasive materials may provide a highly frictional surface, they can, in some examples cause undue wear with surfaces that come into contact with them. In some examples, such as when skin is in direct contact with the highly abrasive materials, contact abrasion may result causing, in some examples, severe discomfort. In other examples, contact between surfaces can cause excessive wear, which may increase indirect costs associated with the use of highly abrasive materials. Thus, low abrasion elastomeric layers may be advantageous in some applications. As such, in embodiments, elastomeric layers may be provided having a hardness in a range of 30 to 120 Shore A, more preferably 55 Shore A. By utilizing an elastomeric hardness that is lower than, equal to, or slightly higher than a hardness of an expected surface, abrasion may be reduced or avoided altogether.

In order to compensate for absence of abrasive materials that provide friction, some embodiments employ a texture on surface 102. For example, a peak-valley depth is the measure of the difference between the highest 114 and lowest points 116 of the textured top surface. A preferred peak-valley depth may be further determined using engineering analysis of the ideal ratio between coefficient of friction and the textured peak-valley depth 112 of the embodiment. In addition, a preferred contact surface area of a peak and surface roughness or finish may be further determined using engineering analysis of the ratio between coefficient of friction and contact surface area of the peak and surface roughness. Still further, a preferred surface roughness may be further determined using engineering analysis of the ratio between coefficient of friction and surface roughness. While peak-valley depth typically affects the friction effect of deformation, contact surface area and surface roughness typically affect the friction effect of adhesion. Additionally, a preferred overall thickness of the sheet material may be further determined using engineering analysis and experimentation between overall thickness and its effect on coefficient of friction. In embodiments, without being bound by theory, elastomeric layers may have a peak valley depth in a range of approximately 0.000 to 0.500 inches, more preferably 0.012 inches. In embodiments, having a 0.000 peak valley depth range, the surface is substantially smooth. As illustrated, surface 102 has a random texture 110. However, in other embodiments, textures may include a patterned texture, a smooth texture, and a matte surface. It may be appreciated that in some embodiments, textured surfaces may be produced during an extrusion or heat fusion process utilizing a textured roller. However, textures may be produced in any manner known in the art without departing from the present invention. As such, by configuration of an appropriate hardness coupled with an appropriate texture, in embodiments, elastomeric layers may be configured to provide a static or a kinetic coefficient of friction in a range of approximately 0.20 to 15.00 COF against a multitude of substrates.

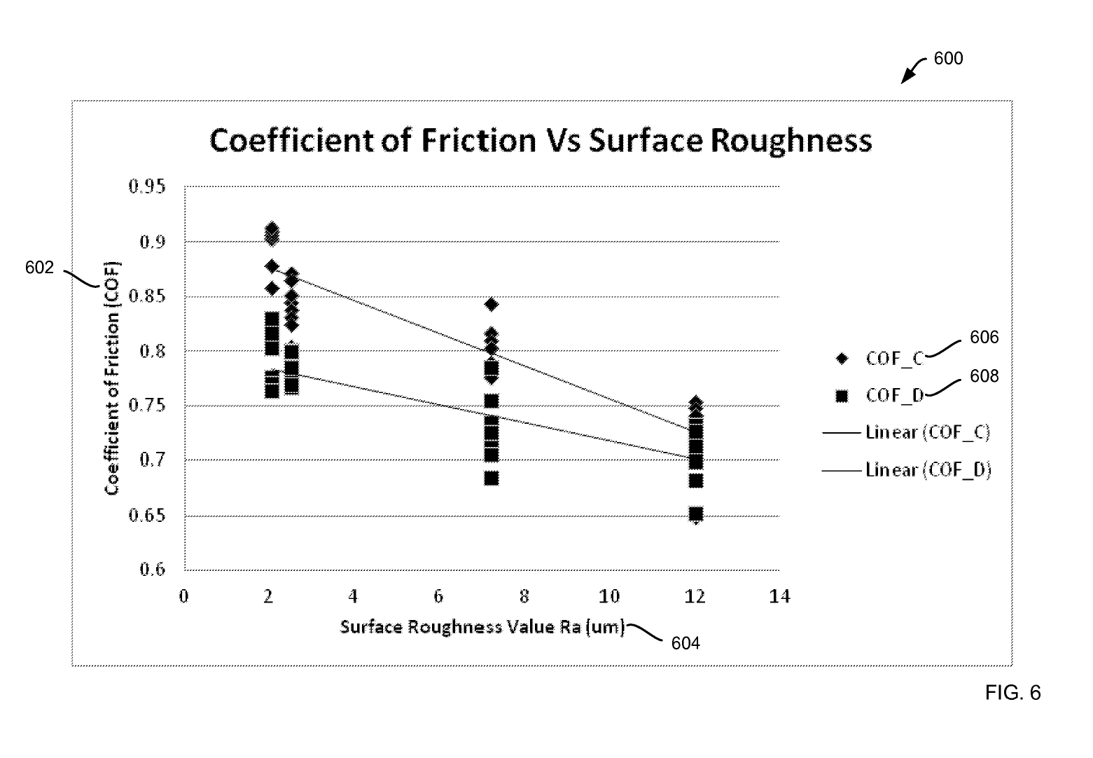

Turning briefly to FIG. 6, FIG. 6 is an illustrative graphical representation 600 of coefficient of friction 602 vs. surface roughness 604 in accordance with embodiments of the present invention. As noted above, various factors contributing to overall coefficient of friction (COF), such as texture, contact surface area, and surface roughness, may be further examined and experimented using engineering analysis. Graphical representation 600 is a simple example of a method for determining and empirically analyzing correlations between coefficient of friction and variable inputs such as accelerated life-testing and surface roughness. Series COF_C 606 is a new sample of an elastomeric material manufactured in accordance with embodiments disclosed herein, and Series COF_D 606 is the same sample after exposure to accelerated life-testing. Surface roughness was measured using a 3-dimensional non-contact surface profilometer at the micron scale. Based specifically on surface roughness the overall COF decreases as the surface roughness value (Ra) increases while COF_C versus COF_D converges to a point as surface roughness increases. The converging series COF_C and COF_D demonstrates that deformation may play an increasingly larger role in the resulting COF values versus adhesion as the two series approach each other and surface roughness increases. Whereas, assuming a higher surface roughness results in higher deformation and a lower surface roughness results in lower deformation, the higher COF at lower surface roughness empirically suggests adhesion properties of the samples provide higher COF values than effects of deformation properties or higher surface roughness. However, the larger delta between COF_C and COF_D at a lower surface roughness suggests that accelerated life-testing of the samples affects adhesion properties more than deformation properties. Therefore, there may be some benefit for increasing surface roughness to preserve COF during life of the product; however the surface roughness should be balanced with texture to provide a COF that most closely matches conventional solutions while limiting loss of COF during the life of the product. In addition, other variables may be further studied to optimize and develop a preferred peak-valley depth, textured pattern, contact surface area, and surface roughness.

Friction can be described as an electromagnetic force between charged particles, which must be calculated through experimentation or empirically. Until recently, the scientific world believed friction was a direct effect of surface roughness; however this does not represent the complete story. On a typical size scale, such as a skateboard, kinetic friction is caused by chemical bonding of two surfaces known as molecular adhesion. In particular, molecular adhesion is when two surfaces intimately contact, and their atoms or molecules attract each other by electromagnetic forces; these forces will from hereafter be referred to as adhesion. Therefore the frictional forces acting on an object are in essence the forces required to break these adhesive bonds. In addition, material composition may also affect adhesion if the material is naturally sticky such as rubber.

Physically, friction work can be described as translating into abrasion/wear, deformation, or heat. As noted above, abrasive grip tapes of the prior art are designed to create friction primarily through abrasion or displacement of material. In particular, conventional abrasive methods provide a frictional surface utilizing one hard material with high surface roughness or asperities to physically interfere with a softer material where particles of the softer material become dislodged from their surface. In this case, surface roughness and differences in hardness are the major contributing factors creating friction with some help from adhesion.

Conversely, embodiments of the present invention are designed to be similar in hardness to a user's shoe and to utilize the effects of deformation and exothermic/heat reaction from adhesion instead of wear or displacement of material from abrasion. In particular, softer materials may deform under pressure, therefore an object moving across this surface must overcome this deformation and further increases resistive forces of friction. In addition, certain materials provide better adhesion coupled with a sticky effect, which may translate to heat when these bonds are broken. Therefore, embodiments of the present invention may be able to achieve similar frictional properties and advantages over abrasive grip tape of the prior art by utilizing deformation and heat transfer identified through analysis from engineering experimentation as well as from the empirical study of effects of adhesion between different materials without one surface abrading another. For example, consider an outdoor basketball court versus indoor basketball court. While both surfaces provide friction, the surface of an indoor court is less abrasive than the surface of an outdoor court, because it provides friction work through deformation and heat transfer or the plow effect and adhesion instead of through interference and abrasion. Thus, sliding across the floor of an indoor court may cause a heat burn against skin while sliding across the floor of an outdoor court may cause a skin abrasion.

In embodiments relating to elastomeric skateboard grip tape the present invention may reduce and prevent wear and tear altogether since the actual forces applied while performing tricks is relatively small. Thereby, the heat generated from this frictional force would not cause much wear and tear against a similar hardness material such as a shoe. Therefore the present invention may provide additional indirect environmental benefit by greatly extending the life of a manufactured product such as a shoe. Consider that embodiments of the present invention may reduce the wear and tear of a shoe, the frequency of needing to replace said shoe, and the amount of shoes needing to be produced for the same purpose, which saves energy, materials, and waste byproducts otherwise associated with manufacturing said shoe.

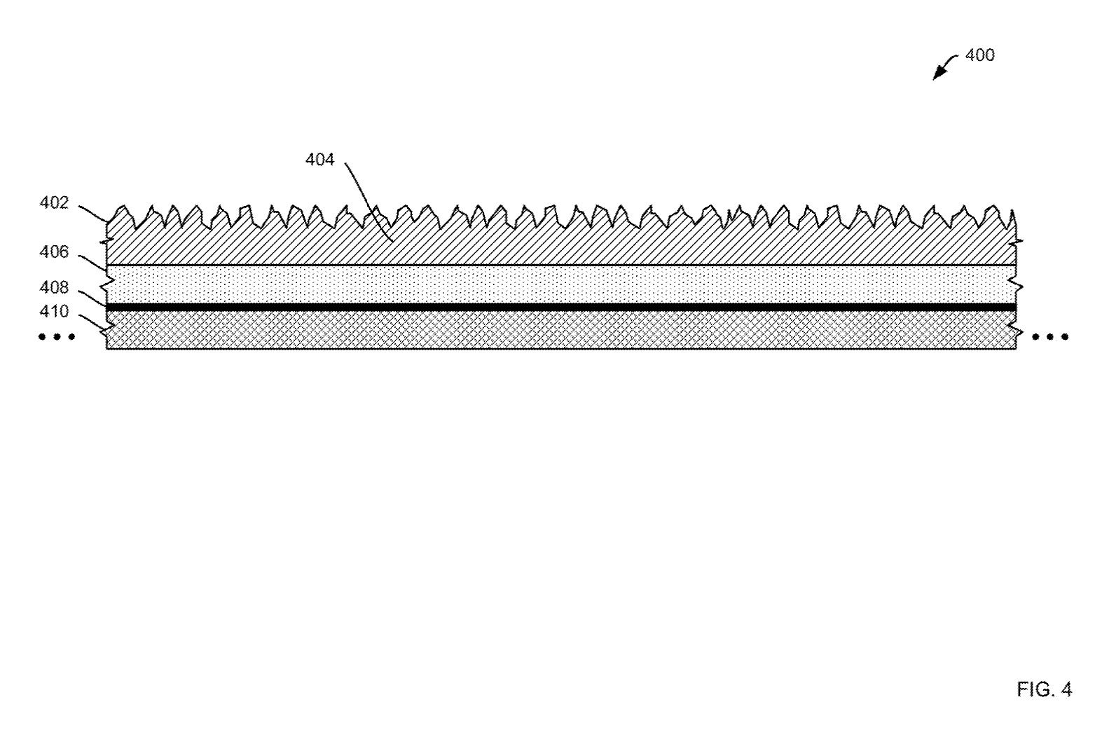

Returning to FIG. 1, as further illustrated, elastomeric grip tape embodiments include pressure sensitive adhesive (PSA) layer 106 formed along the bottom surface of elastomeric layer 104. PSA layers may be configured to bond to elastomeric layers and to target surfaces so that a secure gripping surface may be achieved. As such, PSA layers may include a number of adhesive properties which provide for bonding with different materials. In embodiments, PSA layer may include an acrylic compound, a methacrylate compound, a rubber compound, a water based compound, a solvent based compound, a silicone compound and a styrene compound. As may be appreciated, in embodiments, PSA layers may provide a conformal adhesion equally well with non-planar surfaces as well as planar surfaces. In some embodiments, a release/carrier layer 108 may be removably adhered or coated with PSA layer 106 for convenience in packaging and handling for example. Release layers may be easily removed when bonding to a surface is required. In some embodiments, an underlayer may be utilized which is discussed in further detail below for FIG. 4

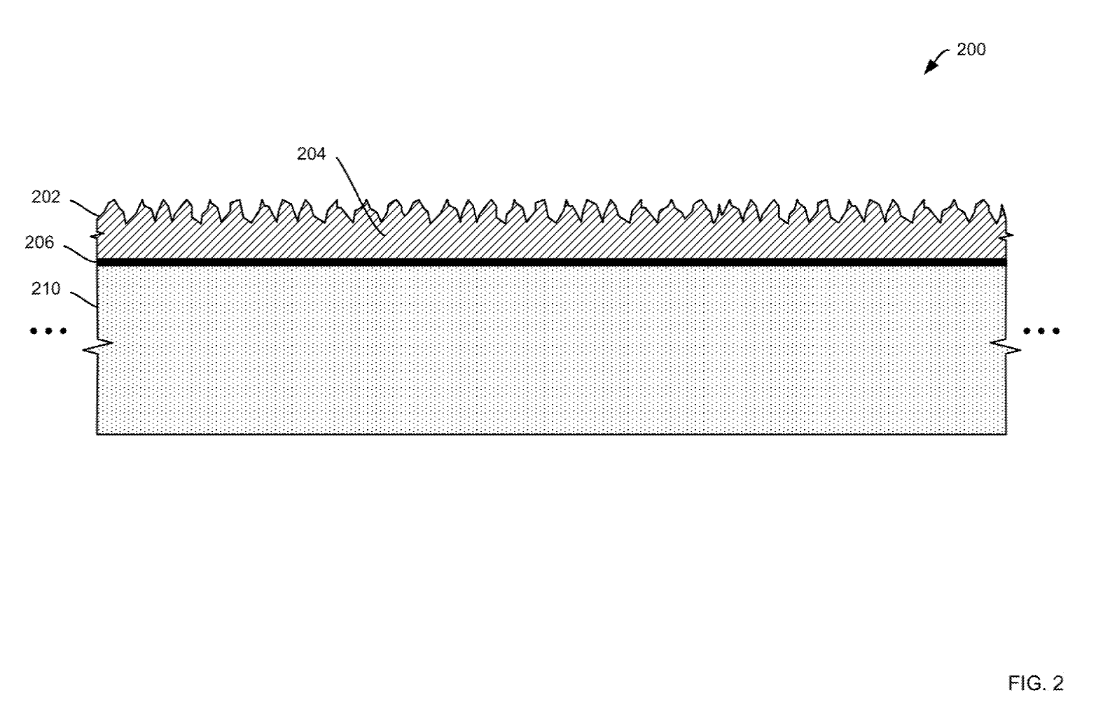

FIG. 2 is an illustrative representation of a cross-sectional view 200 of a portion of an elastomeric layer 204 applied to a surface 210 in accordance with embodiments of the present invention. In particular, elastomeric layer 204 having a randomly textured surface 202 is bonded with a planar surface 210. Elastomeric layer 204 is bonded with planar surface 210 by PSA 206. In some embodiments, planar surfaces include a skateboard. It should be noted that illustrations presented herein are provided for clarity in understanding embodiments disclosed herein and should not be construed as limiting with respect to any dimension such as thickness.

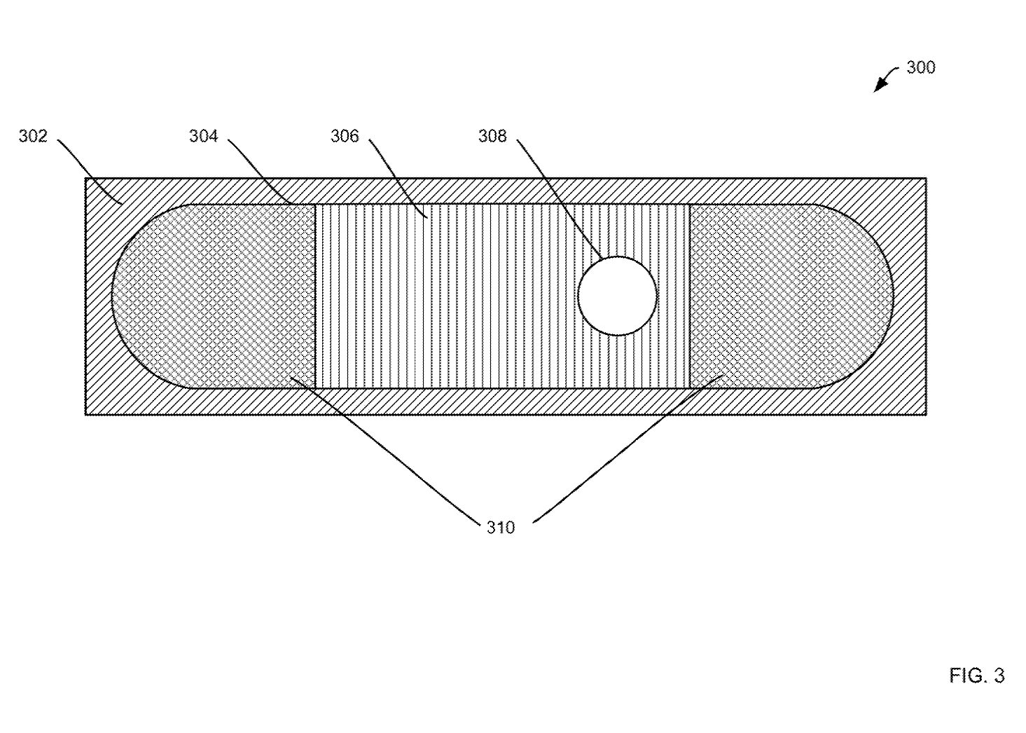

FIG. 3 is an illustrative representation 300 of an elastomeric grip tape 302 as applied to a skateboard in accordance with embodiments of the present invention. In particular, FIG. 3 represents an embodiment having a skateboard cut-out 304. Skateboard cut-outs may be utilized to provide pre-determined shapes—in this case, a skateboard. In other embodiments, cut-outs may define any shape. For example, in one embodiment, round buttons may be defined which may be peeled from release liner and applied to any number of surfaces. Cut-outs may include perforations or pre-cuts, which perforations or pre-cuts may be through cut or partial cut in embodiments. In a skateboard embodiment, different elastomeric grip tape formulations may be utilized for different locations. That is, elastomeric grip tape top surface may vary in texture, material, hardness or the like to provide advantages including but not limited to more/less friction, aesthetics or durability in specific locations. For example, nose and tail texture 310 may provide added friction over center texture 306. In addition, in embodiments, a window of pre-determined size 308 may be perforated, laser cut, or die cut to showcase graphics on an applied surface such as a skateboard. In some embodiments, cut may be configured to allow through hole access such as for bolts/screws. In still other embodiments, window 308 may be manufactured utilizing elastomeric embodiments that are clear such that traction may be maintained over graphics. It may be appreciated that any size or shape may be utilized for window 308 without departing from embodiments provided herein.

FIG. 4 is an illustrative representation of a cross-sectional view 400 of a portion of an elastomeric grip tape in accordance with embodiments of the present invention. In particular, the illustrated portion represents an embodiment prior to application to a surface. As illustrated elastomeric layer 404 may provide a low abrasion frictional surface to another surface. In embodiments, surfaces may be rigid or flexible without limitation. In addition, surfaces may be planar or non-planar without limitation. Conformance with non-planar surfaces is possible because of the elasticity of compounds utilized in embodiments provided herein. As such, elastomeric layers may be manufactured from any number of elastomeric compounds including without limitation: natural rubber, ethylene vinyl acetate (EVA), ethylene propylene diene monomer (EPDM), styrene-butadiene rubber (SBR), nitrile rubber (NBR), thermoplastic elastomers/thermoplastic vulcanizates (TPE/TPV), thermoplastic elastomer polyolefin (TPO), silicone rubber (SI,Q,VMQ), polyacrylic rubber, fluoroelastomers (FKM, FPM), flurosilicone rubber (FVMQ), tetrafluoro ethylene/propylene rubbers (FEPM), chlorosulfonated Polyethylene (CSM), ethylene propylene rubber (EPM), polyisoprene (IR), polybutadiene (BR), polyurethane rubber, and elastomer-based foams. In embodiments, elastomeric layers may have a thickness in a range of approximately 0.010 to 0.500 inches, more preferably 0.020 inches.

As noted above, in some conventional solutions, highly abrasive materials may be utilized to create a highly frictional surface. While highly abrasive materials may provide a highly frictional surface, they can, in some examples cause undue wear with surfaces that come into contact with them. In some examples, such as when skin is in direct contact with the highly abrasive materials, contact abrasion may result causing, in some examples, severe discomfort. In other examples, contact between surfaces can cause excessive wear, which may increase indirect costs associated with the use of highly abrasive materials. Thus, low abrasion elastomeric layers may be advantageous in some applications. As such, in embodiments, elastomeric layers may be provided having a hardness in a range of 30 to 120 Shore A, more preferably 55 Shore A. By utilizing an elastomeric hardness that is lower than, equal to, or slightly higher than a hardness of an expected surface, abrasion may be reduced or avoided altogether.

In order to compensate for absence of abrasive materials that provide friction, some embodiments employ a texture on surface 402. As noted above, preferred peak-valley depth may be further determined using engineering analysis of the ideal ratio between coefficient of friction and the textured peak-valley depth of the embodiment. In addition, a preferred contact surface area of a peak and surface roughness or finish may be further determined using engineering analysis of the ratio between coefficient of friction and contact surface area of the peak and surface roughness. Still further, a preferred surface roughness may be further determined using engineering analysis of the ratio between coefficient of friction and surface roughness. While peak-valley depth typically affects the friction effect of deformation, contact surface area and surface roughness typically affect the friction effect of adhesion. Additionally, a preferred overall thickness of the sheet material may be determined using engineering analysis and experimentation between overall thickness and its effect on coefficient of friction. In embodiments, without being bound by theory, elastomeric layers may have a peak valley depth in a range of approximately 0.000 to 0.500 inches, more preferably 0.012 inches. In embodiments, having a 0.000 peak valley depth range, the surface is substantially smooth. As illustrated, surface 112 has a random texture 110. However, in other embodiments, textures may include a patterned texture, a smooth texture, and a matte surface. It may be appreciated that in some embodiments, textured surfaces may be produced during an extrusion or heat fusion process utilizing a textured roller. However, textures may be produced in any manner known in the art without departing from the present invention. As such, by configuration of an appropriate hardness coupled with an appropriate texture, in embodiments, elastomeric layers may be configured to provide a static or a kinetic coefficient of friction in a range of approximately 0.20 to 15.00 COF against a multitude of substrates.

As further illustrated, elastomeric grip tape embodiments may include underlayer 406. Underlayer embodiments may be utilized to provide mechanical advantages when utilized in combination with elastomeric layers. Consider an embodiment utilizing an elastomeric layer composed of TPE/TPV and an underlayer composed of polypropylene (PP), Polyethylene (PE), or some blend thereof. As may be appreciated, due to the stretching and heating nature of extruding film, TPE/TPV compositions are highly susceptible to shrinkage even after several days post-processing. In this example, the more rigid underlayer material (e.g. PP/PE) may effectively tension and keep TPE/TPV layers from shrinking and thus allow the material to hold a specific form factor after sheeting and applying to a substrate. As such, rigid underlayers may provide for better tear resistance, reduced air bubbles, and easier cutting operations when applying to a substrate such as a skateboard which requires trimming with a razor to the shape of the board. Additionally, a rigid underlayer may reduce material costs since rigid underlayers may be made of a relatively inexpensive material. Still further, in embodiments composed of a UV-resistant underlayer material may provide additional protection for non-UV resistant adhesives such as rubber-based PSAs.

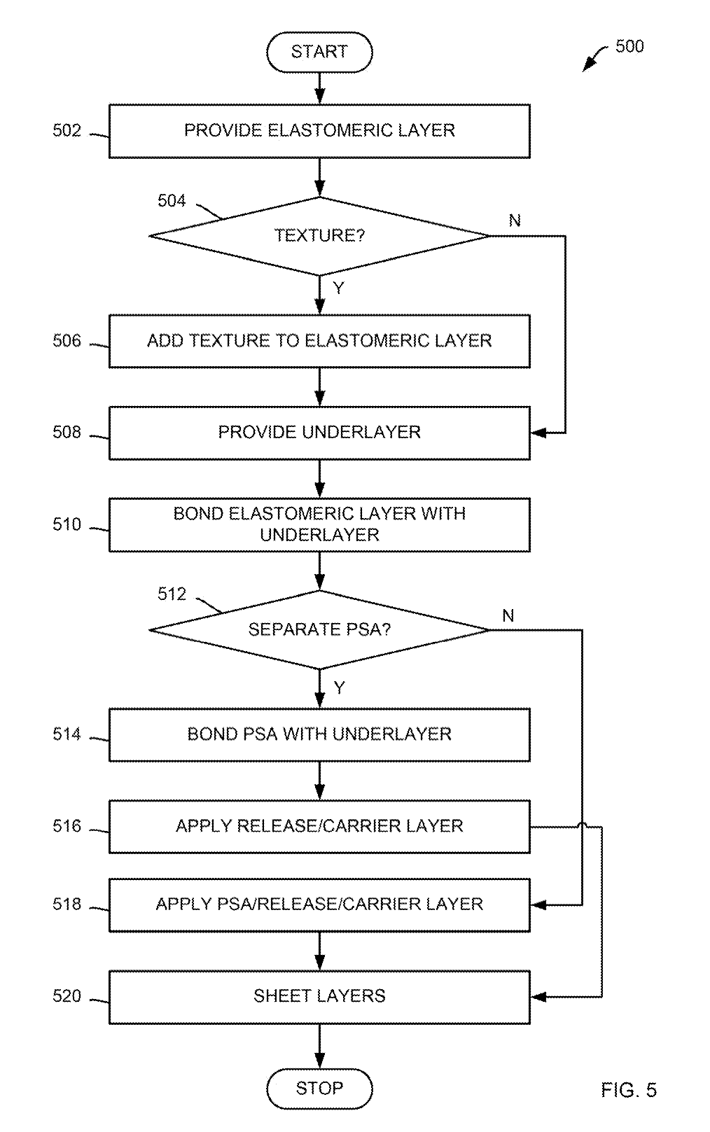

In some embodiments, underlayers may be configured as a sheet structure, a foam structure, a porous structure, a screen structure, a fiber mesh structure, and a mesh structure. In embodiments, a mesh or screen structure may improve bonding by increasing surface energy and heat transfer and by partially encapsulating the mesh structure within an elastomeric layer. The resulting bond may additionally increase overall strength of entire elastomeric grip tape embodiment. In some embodiments, bonding may be further enhanced by treatments such as corona, plasma or flame treatment. In embodiments, underlayers and elastomeric layers may be bonded in any fashion without limitation. In some embodiments, underlayers and elastomeric layers may be heat welded during an extrusion process or separate heat fusion process. Still further, in some embodiments, rigid underlayers may include either a PSA with release layer, a lamination adhesive (i.e. heat activated adhesives or non-heat activated adhesives), or both before being attached with elastomeric layers. In embodiments utilizing underlayers having both a PSA and lamination adhesive; underlayers may be laminated with elastomeric layer during an extrusion process thereby reducing process times. Lamination adhesive and/or surface treatment may greatly improve bonding strength of the elastomeric layer to the underlayer in some embodiments. Manufacturing processes will be discussed in further detail below for FIG. 5. In some embodiments, underlayers may be manufactured from any number of materials and blends including polypropylene (PP), polyvinyl chloride (PVC), polyethylene terephthalate (PET), nylon, polyethylene (PE), polycarbonate (PC), and acrylonitrile butadiene styrene (ABS). In embodiments, underlayers may have a thickness in a range of approximately 0.0005 to 0.0500 inches, more preferably 0.010 inches.

In some embodiments, the rigid underlayer may be a material such as Polypropylene (PP) since it is Polyolefin heat fusion capable like PE because of its carbon chemical structure. Likewise, a material such as PP may greatly benefit from surface treatments as noted above to increase its surface energy or dyne levels during bonding to an elastomeric layer. In addition, PP material is relatively low cost, easy to manufacture and has a relatively high melt temperature. A higher melt temperature may help protect the integrity of the underlayer structure during high temperature bonding to an elastomeric layer especially since many elastomers typically require a higher temperature for heat fusion processes. In addition, a higher heat capacity may, in some instances, reduce process times by utilizing quicker temperature ramps, less dwell time, and less pressure. Still further, a higher heat capacity may reduce the necessary thickness of an underlayer while still being able to withstand higher processing temperatures, which could be beneficial for overall functionality and cost of the present invention. Consider for example, a thinner underlayer bonded to an elastomeric layer, which thereby reduces overall thickness of the present invention and attaches and trims to a substrate such as a skateboard. The above embodiments would be primarily attached to the substrate by the PSA backing, and in this example a thinner overall thickness may help prevent the elastomeric grip tape and PSA layer from peeling up at its edges or sides. In addition, a thinner embodiment would require less material and thereby less material cost. Other advantages include high chemical resistance, environmentally friendly and recyclable.

As further illustrated, elastomeric grip tape embodiments include pressure sensitive adhesive (PSA) layer 408 formed along bottom surface of underlayer 406. PSA layers may be configured to bond to underlayers and to target surfaces so that a secure gripping surface may be achieved. Typically, PSAs designed to bond with elastomeric layer materials are less durable and more costly, therefore bonding to an underlayer material instead of an elastomeric layer material may allow for a more durable and less costly PSA. As such, PSA layers may include a number of adhesive properties which provide for bonding with different materials. In some embodiments, PSA layers may be manufactured to have a peel strength in a range of approximately 1 to 20 pounds or more per linear inch (PLI), more preferably approximately 7 PLI when attached to a multitude of various substrates such as a skateboard for example. In order to aid in air bubble release during application to a substrate, in some embodiments, PSA layers may be formed having a textured surface which allows air to channel out from under the elastomeric grip tape during application. Textures may be formed during application of a release layer, which layer is discussed in further detail below. In embodiments, PSA layers may include an acrylic compound, a methacrylate compound, a rubber compound, a water based compound, a solvent based compound, a silicone compound and a styrene compound. As may be appreciated, in embodiments, adhesives may provide a conformal adhesion equally well with non-planar surfaces as well as planar surfaces.

In some embodiments, a release/carrier layer 410 may be releasably applied with PSA layer 410 for convenience in packaging and handling for example. Release layers may be easily removed when bonding to a substrate is required. As noted above, textures in PSA layers may be formed during application of a release layer. Textures of PSA layers may include channels and ridges which may aid in air bubble release during application to a substrate.

FIG. 5 is an illustrative flowchart of methods for manufacturing of an elastomeric grip tape in accordance with embodiments of the present invention. At a first step, an elastomeric layer may be provided. As noted above, elastomeric layers may be manufactured from any number of elastomeric compounds including without limitation: natural rubber, ethylene vinyl acetate (EVA), ethylene propylene diene monomer (EPDM), styrene-butadiene rubber (SBR), nitrile rubber (NBR), thermoplastic elastomers/thermoplastic vulcanizates (TPE/TPV), thermoplastic elastomer polyolefin (TPO), silicone rubber (SI,Q,VMQ), polyacrylic rubber, fluoroelastomers (FKM, FPM), flurosilicone rubber (FVMQ), tetrafluoro ethylene/propylene rubbers (FEPM), chlorosulfonated Polyethylene (CSM), ethylene propylene rubber (EPM), polyisoprene (IR), polybutadiene (BR), polyurethane rubber, and elastomer-based foams. In some embodiments, elastomeric layers are provided in sheets for suitable for roller based processes. In embodiments, elastomeric layers may have a thickness in a range of approximately 0.010 to 0.500 inches, more preferably 0.020 inches.

As noted above, in some conventional solutions, highly abrasive materials may be utilized to create a highly frictional surface. While highly abrasive materials may provide a highly frictional surface, they can, in some examples cause undue wear with surfaces that come into contact with them. In some examples, such as when skin is in direct contact with the highly abrasive materials, contact abrasion may result causing, in some examples, severe discomfort. In other examples, contact between surfaces can cause excessive wear, which may increase indirect costs associated with the use of highly abrasive materials. Thus, low abrasion elastomeric layers may be advantageous in some applications. As such, in embodiments, elastomeric layers may be provided having a hardness in a range of 30 to 120 Shore A, more preferably 55 Shore A. By utilizing an elastomeric hardness that is lower than, equal to, or slightly higher than a hardness of an expected surface, abrasion may be reduced or avoided altogether.

At a next step, 504, the method determines whether a texture is required. As noted above, in order to compensate for absence of abrasive materials that provide friction, some embodiments may employ a texture on elastomeric surfaces having a defined peak-valley depth. A peak-valley depth is the measure of the difference between the highest and lowest points of a textured top surface. A preferred peak-valley depth may be further determined using engineering analysis of the ideal ratio between coefficient of friction and the textured peak-valley depth of the embodiment. In addition, a preferred contact surface area of a peak may be further determined using engineering analysis of the ratio between coefficient of friction and contact surface area of the peak. Still further, a preferred surface roughness may be further determined using engineering analysis of the ratio between coefficient of friction and surface roughness. While peak-valley depth typically affects the friction effect of deformation, contact surface area and surface roughness typically affect the friction effect of adhesion. Additionally, the preferred overall thickness of the sheet material may be determined using engineering analysis and experimentation between overall thickness and its effect on coefficient of friction. In embodiments, without being bound by theory, elastomeric layers may have a peak valley depth in a range of approximately 0.000 to 0.500 inches, more preferably 0.012 inches. In embodiments, having a 0.000 peak valley depth range, the surface is substantially smooth. Thus, methods may determine whether a texture or a smooth surface is required. If the method determines at a step 504 that a texture is not required, the method continues to a step 508. If the method determines at a step 504 that a texture is required, the method continues to a step 506 to add a texture to an elastomeric layer. In some embodiments, texture may be added while bonding an underlayer as described in a step 510 below. Textures may include a patterned texture, a smooth texture, and a matte surface without limitation. It may be appreciated that in some embodiments, textured surfaces may be produced during an extrusion process utilizing a textured roller. However, textures may be produced in any manner known in the art without departing from the present invention. Indeed, it may be appreciated that, in some embodiments, textures may be pre-pressed into provided elastomeric layers thus eliminating a need to add textures during manufacturing of elastomeric grip tape embodiments. Textures may be formed at a process temperature in a range of approximately 50 to 350 Celsius and a rolling pressure in a range of approximately 1 to 20,000 psi.

At a next step 508, the method provides an underlayer. Underlayer embodiments may be utilized to provide mechanical advantages when utilized in combination with elastomeric layers. Consider an embodiment utilizing an elastomeric layer composed of TPE/TPV and an underlayer composed of polypropylene (PP) and polyethylene (PE) blend. As may be appreciated, due to the stretching and heating nature of extruding film, TPE/TPV may be highly susceptible to shrinkage even after several days post-processing. In this example, the more rigid underlayer material (e.g. PP/PE) may effectively keep TPE/TPV layers from shrinking and thus allow the material to hold a specific form factor after sheeting and applying to a substrate. In some embodiments, underlayers may be configured as a sheet structure, a foam structure, a porous structure, a screen structure, a fiber mesh structure, and a mesh structure. This type of structure may improve bonding by increasing surface energy and heat transfer and by partially encapsulating the mesh structure within an elastomeric layer. The resulting bond may additionally increase overall strength of entire elastomeric grip tape embodiment. In some embodiments, bonding may be further enhanced by treatments such as corona, plasma, or flame treatment. In embodiments, underlayers may be manufactured from any number of materials and blends including polypropylene (PP), polyvinyl chloride (PVC), polyethylene terephthalate (PET), nylon, polyethylene (PE), polycarbonate (PC), and acrylonitrile butadiene styrene (ABS). In embodiments, underlayers may have a thickness in a range of approximately 0.0005 to 0.0500 inches, more preferably 0.010 inches.

At a next step, 510, the method bonds an elastomeric layer with an underlayer. In embodiments, underlayers and elastomeric layers may be bonded in any fashion without limitation. In some embodiments, underlayers and elastomeric layers may be heat welded during a rolling process. In other embodiments, a texture may be added to elastomeric layers during heat welding to provide additional production efficiencies. Heat welding may occur at a process temperature in a range of approximately 50 to 350 Celsius and a rolling pressure in a range of approximately 1 to 20,000 psi.

At a next step 512, the method determines whether a separate PSA layer is applied to an underlayer. In embodiments, PSA layers may be added separately or in combination with a release/carrier layer. As such, if the method determines at a step 512 that a separate PSA layer is applied to an underlayer, the method continues to a step 514, a pressure sensitive adhesive is provided. In embodiments, PSA layers may include an acrylic compound, a methacrylate compound, a rubber compound, a water based compound, a solvent based compound, a silicone compound and a styrene compound. As may be appreciated, in embodiments, adhesives may provide a conformal adhesion equally well with non-planar surfaces as well as planar surfaces. In some embodiments, PSA layers may be manufactured to have a peel strength of in a range of approximately 1 to 20 pounds per linear inch (PLI), more preferably approximately 7 PLI. At a next step 514, PSA layer is bonded with an underlayer. In embodiments, underlayers and PSA layers may be bonded in any fashion without limitation. In some embodiments, underlayers and PSA layers may be laminated during a rolling process. Laminating may occur at a process temperature in a range of approximately 50 to 350 Celsius and a rolling pressure in a range of approximately 1 to 20,000 psi. In other embodiments, underlayers may be sprayed onto underlayer surfaces. Curing may occur in spraying embodiments. In embodiments where an underlayer is provided with a PSA, release layer/carrier, and lamination type adhesive (i.e. heat activated adhesives or non-heat activated adhesives) or any combination thereof, the underlayer may be bonded with the elastomeric layer during the extrusion or texture process and continue to a next step, 520, for sheeting. Furthermore, the underlayer may be bonded utilizing a temperature controlled roller and pressure, or with an added shielded roller to protect, for example, the top texture of the elastomeric layer from being heated and changing the final texture while still adequately heating the bottom of the elastomeric layer to be attached to the underlayer. In addition, surface treatments may greatly increase surface energy or dyne levels to promote wetting and adhesion of layers to one another.

At a next step 516, a release/carrier layer may be releasably applied with a PSA layer. Release/carrier layers may be easily removed when bonding to a substrate is required. Applying release/carrier layers may be applied in any manner well-known in the art without departing from embodiments provided herein. Returning to a step 512, if the method determines at a step 512 that a separate PSA layer is not applied to an underlayer, the method continues to a step 520 to bond a PSA/Release/Carrier combination with an underlayer whereupon the method continues to a step 520. In some embodiments, a PSA may be coated onto a release/carrier layer prior to bonding with an underlayer and subsequently baked to activate the PSA. At a step 520, the method continues to a sheeting process whereby embodiments are cut into smaller rolls, sheets, or shapes.

In addition, as noted above, textures in PSA layers may be formed during application of a release layer. Textures of release layers that may be transmitted to a PSA layer may include channels and ridges which may aid in air bubble release during application to a substrate. It may be noted that in some embodiments, through perforations may be formed with elastomeric grip tape embodiments which perforations may take any shape or size without limitation. It may also be appreciated that productions methods illustrated herein may include various combinations and variations of materials and precursors may be utilized without limitation and without departing from embodiments provided herein. As an example, in an embodiment, an underlayer having a PSA/Release/Carrier combination may be received and bonded with elastomeric layers. The method then ends.

While this invention has been described in terms of several embodiments, there are alterations, permutations, and equivalents, which fall within the scope of this invention. It should also be noted that there are many alternative ways of implementing the methods and apparatuses of the present invention. Furthermore, unless explicitly stated, any method embodiments described herein are not constrained to a particular order or sequence. Further, the Abstract is provided herein for convenience and should not be employed to construe or limit the overall invention, which is expressed in the claims. It is therefore intended that the following appended claims be interpreted as including all such alterations, permutations, and equivalents as fall within the true spirit and scope of the present invention.

What is claimed is:

1. An elastomeric grip tape comprising:
an elastomeric layer, wherein
the elastomeric layer is a low-abrasion layer having a hardness in a range of approximately 30 to 120 Shore A, and wherein
the elastomeric layer includes a top surface formed having a first texture with a peak-valley depth in a range of approximately 0.000 to 0.500 inches;
a pressure sensitive adhesive (PSA) layer formed along a bottom surface of the elastomeric layer.

2. The elastomeric grip tape of claim 1, further comprising
an underlayer bonded with the bottom surface of the elastomeric layer wherein the PSA layer is formed along a bottom surface of the underlayer.

3. The elastomeric grip tape of claim 1, wherein the elastomeric layer is manufactured from an elastomeric compound selected from the group consisting of: natural rubber, ethylene vinyl acetate (EVA), ethylene propylene diene monomer (EPDM), styrene-butadiene rubber (SBR), nitrile rubber (NBR), thermoplastic elastomers/thermoplastic vulcanizates (TPE/TPV), thermoplastic elastomer polyolefin (TPO), silicone rubber (SI,Q,VMQ), polyacrylic rubber, fluoroelastomers (FKM, FPM), flurosilicone rubber (FVMQ), tetrafluoro ethylene/propylene rubbers (FEPM), chlorosulfonated polyethylene (CSM), Ethylene propylene rubber (EPM), polyisoprene (IR), polybutadiene (BR), polyurethane rubber, and elastomer-based foams.

4. The elastomeric grip tape of claim 2, wherein the underlayer is manufactured from a compound selected from the group consisting of: polypropylene (PP), polyvinyl chloride (PVC), polyethylene terephthalate (PET), nylon, polyethylene (PE), polycarbonate (PC), acrylonitrile butadiene styrene (ABS) and any combination of those compounds.

5. The elastomeric grip tape of claim 4, wherein the underlayer further includes a lamination adhesive for bonding with the bottom surface of the elastomeric layer wherein the lamination adhesive is selected from the group consisting of a heat activated adhesive and a non-heat activated adhesive.

6. The elastomeric grip tape of claim 4, wherein the underlayer includes a configuration selected from the group consisting of: a sheet structure, a foam structure, a porous structure, a screen structure, a fiber mesh structure, and a mesh structure, wherein the underlayer has a thickness in a range of approximately 0.0005 to 0.0500 inches.

7. The elastomeric grip tape of claim 1, wherein the PSA layer is selected from the group consisting of: an acrylic compound, a methacrylate compound, a rubber compound, a water based compound, a solvent based compound, a silicone compound and a styrene compound.

8. The elastomeric grip tape of claim 1, further including:
a release/carrier layer releasably applied with the PSA layer for temporarily protecting the PSA layer.

9. The elastomeric grip tape of claim 8, wherein the release/carrier layer includes a second texture configured to transmit the second texture to the PSA layer.

10. The elastomeric grip tape of claim 1, wherein the first texture is selected from the group consisting of: a random texture, a patterned texture, a smooth texture, and a matte surface.

11. The elastomeric grip tape of claim 1, wherein the peak-valley depth is approximately 0.012 inches.

12. The elastomeric grip tape of claim 1, wherein the elastomeric layer provides a static or a kinetic coefficient of friction in a range of approximately 0.20 to 15.00 COF against a plurality of substrates.

13. The elastomeric grip tape of claim 1, wherein the elastomeric layer has a thickness in a range of approximately 0.010 to 0.500 inches.

14. The elastomeric grip tape of claim 8, further including:
a plurality of perforations defining a shape which shape may be adhered to a surface.

15. A method of manufacture of an elastomeric grip tape comprising:
providing an elastomeric layer, wherein
the elastomeric layer is a low-abrasion layer having a hardness in a range of approximately 30 to 120 Shore A, and wherein
the elastomeric layer includes a top surface formed having a first texture with a peak-valley depth in a range of approximately 0.000 to 0.500 inches;
providing a pressure sensitive adhesive (PSA) layer; and
bonding the PSA layer with a bottom surface of the elastomeric layer.

16. The method of claim 15, further comprising:
providing an underlayer;
bonding the elastomeric layer with the underlayer;
providing the pressure sensitive adhesive (PSA) layer; and
bonding the PSA layer with a bottom surface of the underlayer.

17. The method of claim 15, further comprising:
providing an underlayer, underlayer including a PSA layer bonded to a bottom surface of the underlayer; and
bonding the elastomeric layer with the underlayer.

18. The method of claim 15, further comprising:
applying a release/carrier layer with the PSA layer for temporarily protecting the PSA layer.

19. The method of claim 15, further comprising: treating the underlayer by a treatment selected from the group consisting of: corona treatment, flame treatment and plasma treatment.

20. An elastomeric grip tape including:
an elastomeric layer, wherein
the elastomeric layer is a low-abrasion layer having a hardness in a range of approximately 30 to 120 Shore A, and wherein
the elastomeric layer includes a top surface formed having a first texture with a peak-valley depth in a range of approximately 0.000 to 0.500 inches;
an underlayer bonded with the bottom surface of the elastomeric layer, wherein the underlayer includes lamination adhesive for bonding with the bottom surface of the elastomeric layer;
a pressure sensitive adhesive (PSA) layer formed along a bottom surface of the underlayer; and
a release/carrier layer releasably applied with the PSA layer for temporarily protecting the PSA layer.
